(19) United States
(12) Patent Application Publication
(10) Pub. No.: US 2008/0222400 A1
(43) Pub. Date: Sep. 11, 2008

(54) Power Consumption of a Microprocessor Employing Speculative Performance Counting

(75) Inventors: Daniel Becker, Meckenheim (DE); Cedric Lichtenau, Stuttgart (DE); Thomas Pflunger, Leinfelden (DE); Matthias Woehrle, Bietighheim-Billingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 12/043,168

(22) Filed: Mar. 6, 2008

(30) Foreign Application Priority Data
Mar. 7, 2007 (EP) 07103664.4

(51) Int. Cl. G06F 9/312

(52) U.S. Cl. 712/225; 712/E09.033

(57) ABSTRACT

Reduction of power consumption and chip area of a microprocessor employing speculative performance counting, comprising splitting a counter and a backup register of a speculative counting mechanism performing the speculative performance counting into first and second parts each, re-using an available storage within the microprocessor as first parts respectively; integrating at least one dedicated pre-counter into the microprocessor as second parts respectively; splitting the data handled by the speculative counting mechanism in high-order and low-order bits; storing the high order bits in the first parts; storing the low order bits in the second parts; updating the first parts periodically; and saving and propagating the carry-out from the second parts to high-order bits when a corresponding first part of the second parts is next updated respectively.

### BACKGROUND OF THE INVENTION

The present invention relates to a method to reduce power consumption of a microprocessor employing speculative performance counting. More particularly the invention relates to a method to re-use existing available storage within a microprocessor for speculative performance counting. Further the invention relates to a speculative counting mechanism re-using existing available storage within a microprocessor and a microprocessor comprising at least one such speculative counting mechanism.

Current microprocessors commonly provide a facility for performance monitoring, the so-called performance monitoring unit (PMU). The PMU comprises a set of performance monitoring counters (PMCs) that track the occurrence of performance related events inside the microprocessor.

The statistics derived from the counted events allow hardware designers to measure the microprocessor's real-world performance and to identify weaknesses in the architecture, possibly leading to improvements for future microprocessor generations. In addition, the performance monitor can be used by software developers for code profiling and optimization.

Modern microprocessors commonly employ speculative execution to improve performance. Using sophisticated branch prediction algorithms, processors select the code path that is most likely to be followed and begin speculatively executing the instructions found in that path before the actual branch target is established. If the branch prediction subsequently turns out to be incorrect, the speculatively executed instructions are discarded and the processor begins fetching instructions along the correct path.

For deriving performance metrics, it is desirable not to count performance events generated by speculatively executed instructions that are later on discarded.

U.S. Pat. No. 6,910,120 B2 relates to a method for maintaining a correct value in a PMC within a microprocessor employing speculative execution. The method allows adjusting performance counter values such that only those performance events that are generated by non-speculative instructions, that is, by instructions along the correct path, are reflected in the PMC values. This is also known as speculative counting. Speculative counting is facilitated by adding a dedicated backup register to each counter, which is copied from and to the latter in response to certain control signals.

FIG. 1 shows a current technique of speculative counting. A first row 12 indicates speculative execution periods by horizontal lines 13. A second row 14 indicates events to be counted by dotted arrows 15. A third row 16 visualizes the counting of successive events as a sequence of counter values. A fourth row 17 shows a timeline view of the backup values. It can be seen that events indicated by the dotted arrows 18 within speculative execution periods 19 that turn out to be incorrect, generally are reflected in the counter values shown in row 16, but are not reflected in the backup values shown in row 17. Further, every time a speculative execution period 19 turns out to be incorrect, that is, whenever a RESET event occurs, the backup value 17 is copied to the counter value 16, resetting the counter value to the last non-speculative value. This is indicated by the arrows 110 between rows 16 and 17. Further, the backup value 17 is updated to match the current counter value 16 every time a speculative execution period 111 is actually completed, that is, whenever a STORE event occurs. This is indicated by the arrows 112 between rows 16 and 17.

FIG. 2 depicts an example of a current implementation: A microprocessor 21 contains a plurality of speculative counter mechanisms 22. Each speculative counter comprises a counter 23, which holds the current counter value 16. The instance of this counter associated with a given speculative counting mechanism is henceforth referred to as CTR(i), with i denoting the index of the speculative counter if a plurality of such exist. Each speculative counter also comprises a backup register 24, which holds the backup value 17; this is henceforth referred to as BACK(i). Furthermore, it includes control logic 25 that processes RESET and STORE signals. In response to incoming events, the various speculative counter instances are continuously and concurrently updated.

In addition to accounting for the effects of speculative execution, the speculative counting mechanism described in U.S. Pat. No. 6,910,120 B2 can also be used for obtaining other important performance metrics. For example, U.S. Pat. No. 7,051,177 B2 relates to a speculative counting mechanism for measuring memory latency in a multi-level hierarchical memory system. Further, U.S. Pat. No. 7,047,398 B2 relates to a method for using the speculative counting mechanism to measure instruction completion delays.

In summary, a speculative counting mechanism allows performance engineers to easily and accurately derive various important performance metrics that can be used to optimize software performance and to help with design decisions for future microprocessor generations.

However, current implementations of speculative counting mechanisms may incur overhead in terms of chip area and power consumption due to the latches required for adding a backup register of the same width to each counter.

### SUMMARY OF THE INVENTION

Since power consumption is a major problem within modern microprocessors, it is thus an object of the an embodiment of the invention to provide a method to reduce power consumption and chip area of a microprocessor comprising at least one speculative counting mechanism to employ speculative performance counting. It is further an object to provide a speculative counting mechanism and a microprocessor employing speculative counting to be used to execute such a method.

In one aspect, in accordance with an embodiment of the invention, a method is disclosed to reduce power consumption and chip area of a microprocessor employing speculative performance counting with at least one speculative counting mechanism comprising at least one counter and at least one backup register. The method comprises splitting the counter and the backup register of the speculative counting mechanism into two parts each, re-using at least a part of an already existing available storage within the microprocessor as first parts of the counter and the backup register respectively; integrating at least one dedicated pre-counter into the microprocessor as second parts of the counter and the backup register respectively; splitting the data of the speculative performance counting handled by the speculative counting mechanism in high-order bits and low-order bits; storing the high order bits in the first parts of the counter and the backup register; storing the low order bits in the second parts of the counter and the backup register; updating the first parts of the counter and the backup register periodically; and saving and propagating the carry-out from the second part of the counter and/or the backup register to high-order bits when a corresponding first part of the counter and/or the backup register is next updated respectively.

A feature of the method according to an embodiment of the invention is that because logically, each backup register needs to be of the same width as its corresponding counter as defined in the microprocessor's architecture in order to ensure proper operation of a speculative counting mechanism, reduced latch count of the speculative counting mechanism resulting in an increased overall efficiency of the microprocessor can only be achieved by re-using already available storage within the microprocessor for the speculative counting mechanism. Since further the total volume of performance data, that is, data handled by the speculative counting mechanism is a fixed quantity determined by the number and width of architected counters for speculative counting, sufficient storage for all counters must be available. Due to this a reduction in power of the logic inside a microprocessor dedicated to implement the speculative counting mechanism is only possible by re-using existing available storage for the speculative counting mechanism. A potential candidate for re-use is the trace array, since PMUs usually responsible for speculative counting within a microprocessor and trace arrays are normally used in disjoint phases of a microprocessor's product life cycle.

This is achieved by splitting the counter and backup register of at least one, but preferably of each speculative counting mechanism within a microprocessor into a first and second part each. Further at least a part of an already existing available storage within the microprocessor is re-used to store the first part of the counter and the first part of the backup register respectively. Additionally a dedicated pre-counter is integrated into the microprocessor as the second part of the counter and the backup register respectively. Thereby only one part, the second ones herein, of the counter and the backup register respectively need to be quickly and continuously updated, wherein the other part can reside in slower but more efficient storage respectively that can only be updated periodically, such as, for example, a trace array. At least one small but dedicated pre-counter for each counter and backup register is added to the microprocessor as second parts of the counter and the backup register respectively. Now, according to an embodiment of the invention, at least, for example, some rows of, for example, the trace array together with the dedicated pre-counters and associated control logic form a speculative counting mechanism resulting in a microprocessor, comprising at least one speculative counting mechanism and employing speculative performance counting, that is smaller in chip area and has a lower power consumption than a similar current microprocessor, where the whole speculative counting mechanism has to be inserted additionally into the microprocessor.

In order to use the new, split speculative counting mechanism, first the data of the speculative performance counting handled by the speculative counting mechanism are split in high-order and low-order bits.

Second, the high order bits are stored in the first parts of the counter and the backup register, and are thus located in a typically slower but more efficient storage on the microprocessor, such as, for example, a trace array row.

Third, the low order bits are stored in at least one dedicated pre-counter that continuously accepts updates and forms the second parts of the counter and the backup register. Those pre-counters have to be integrated into the microprocessor. Those dedicated pre-counters are smaller in chip area and power consumption than a single or a set of complete speculative counting mechanisms according to the prior art actually integrated in microprocessors to track the occurrence of performance related events inside the microprocessor.

Fourth, the first parts of the counter and the backup register, which are, for example, stored in a trace array row, are only updated periodically.

Fifth, the carry-out from the second part of the counter and/or the backup register is saved and propagated to high-order bits when the corresponding first part of the counter and/or the backup register is next updated respectively.

If multiple speculative counters are implemented in a processor, and thus multiple array rows are used to hold the corresponding first parts of the counters and backup registers, these rows are updated according to a predefined update scheme. In one example of a straightforward update scheme, the rows are visited in sequential order, that is, in a round-robin fashion. The round-robin row access increases counter read/write access latency because software must retrieve the data stored in both parts of the split speculative counting mechanism, that is, both the high- and low-order bits. Therefore, read/write accesses for a particular counter have to be delayed until the array row containing the corresponding first parts is next updated. However, it should be noted that the procedure according to an embodiment of the invention has neither impact on counting functionality nor on accuracy. Furthermore, the overall performance impact is negligible because software read/write accesses to the counters are rare and usually interspersed by long measurement intervals which only have counting activity.

The method according to an embodiment of the invention has an advantage over current techniques in that it allows the re-use of already available storage such as, for example, trace arrays within a microprocessor for speculative performance counting, allowing to reduce silicon area of a microprocessor. Doing so reduces power consumption and due to this increase the efficiency of a microprocessor.

In another preferred embodiment of said method according to an embodiment of the invention, read/write requests are injected between successive updates. If two or more speculative counting mechanisms are foreseen for speculative counting and if at least the first parts of the counters and the backup registers of the speculative counting mechanisms are updated in a round robin fashion, read/write accesses would have to be delayed until the array row corresponding to a particular counter is to be updated next. By injecting read/write requests between successive updates, access latency can be reduced.

According to an additional preferred embodiment of the method according to an embodiment of the invention, the available storage re-used to hold the first parts of the counter and the backup register of the speculative counting mechanism comprises at least a row of a trace array. Trace arrays are memory arrays that hold traces of debug data and which are used extensively during hardware bring up and lab debug within a microprocessor, but rarely in the field. Trace arrays are thus ideally suited to being re-used particularly when using the speculative counting mechanism for a PMU, since PMU and trace arrays are normally used in disjoint phases of a microprocessor's product life cycle.

Preferably, the speculative performance counting is employed in a performance monitoring unit comprising the split speculative counting mechanism.

In another aspect, according to an embodiment of the invention, disclosed is a speculative counting mechanism.

In one embodiment, a speculative counting mechanism for a microprocessor employing speculative performance counting comprises at least one counter and at least one backup register that are both split into a first and a second part respectively, wherein the first parts are formed by an already existing available storage within the microprocessor, and wherein the second parts are formed by at least one dedicated pre-counter integrated into the microprocessor, wherein the data of the speculative performance counting handled by said speculative counting mechanism are split in high-order and low-order bits in a way that the high order bits are stored in the first parts of the counter and the backup register and the low order bits are stored in the second parts of the counter and the backup register, wherein the first parts of the counter and the backup register are updated periodically and the carry-out from a second part of the counter and/or the backup register is saved and propagated to high-order bits every time the corresponding first part of the counter and/or the backup register is next updated.

Preferably the first parts of the counter and the backup register are at least a part like e.g., at least a row of a trace array of a microprocessor the sequential counting mechanism can be integrated into. Trace arrays are ideal to be re-used for the first parts of the speculative counting mechanism particularly when using the speculative counting mechanism for a PMU, since PMU and trace arrays are normally used in disjoint phases of a microprocessor's product life cycle.

According to a preferred embodiment of the invention, the speculative counting mechanism is at least a part of a PMU.

In yet another aspect, in accordance with an embodiment of the invention, disclosed is a microprocessor employing speculative performance counting with at least one speculative counting mechanism.

A microprocessor is disclosed employing speculative performance counting with at least one speculative counting mechanism comprising at least one counter and at least one backup register. The counter and the backup register are split into a first and a second part respectively, wherein the first parts of the counter and the backup register are formed by an already existing available storage within the microprocessor, and wherein the second parts of the counter and the backup register are formed by at least one dedicated pre-counter integrated into the microprocessor, wherein the data of the speculative performance counting handled by the speculative counting mechanism are split in high- and low-order bits in a way that the high order bits are stored in the first parts of the counter and the backup register and the low order bits are stored in the second parts of the counter and the backup register, wherein the first parts of the counter and the backup register are updated periodically and the carry-out from the second part of the counter and/or the backup register is saved and propagated to high-order bits every time the corresponding first part of the counter and/or the backup register is next updated.

Preferably, the first parts of the counter and the backup register are at least a part such as, for example, a row of a trace array that is an existing, available storage within a microprocessor. Particularly, if the speculative counting mechanism is part of a PMU within the microprocessor trace arrays are ideal, since PMU and trace arrays are normally used in disjoint phases of a microprocessor's product life cycle.

According to a preferred embodiment of the microprocessor according to an embodiment of the invention, the microprocessor comprises a PMU comprising the split speculative counting mechanism.

### BRIEF DESCRIPTION OF THE DRAWINGS

The foregoing, together with other objects, features, and advantages of this invention can be better appreciated with reference to the following specification, claims and drawings.

FIG. 1 shows schematically a speculative counting according to the prior art;

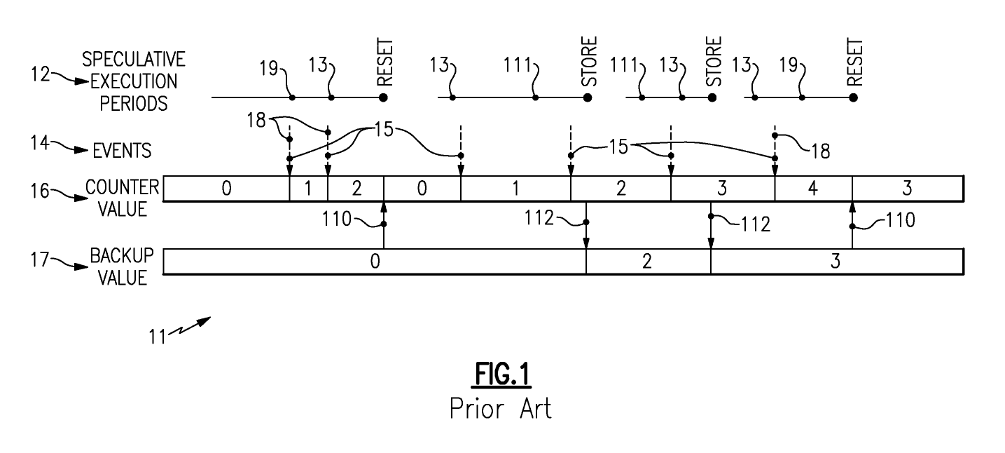

FIG. 2 shows schematically an implementation for speculative counting according to the prior art;

FIG. 3 shows schematically an implementation of a speculative counting mechanism according to an embodiment of the invention;

FIG. 4 shows a flow chart for the operation of a pre-counter control logic that is part of a speculative counting mechanism according to an embodiment of the invention;

FIG. 5 shows a flow chart for the operation of an array control logic that is part of a speculative counting mechanism according to an embodiment of the invention; and

### DETAILED DESCRIPTION

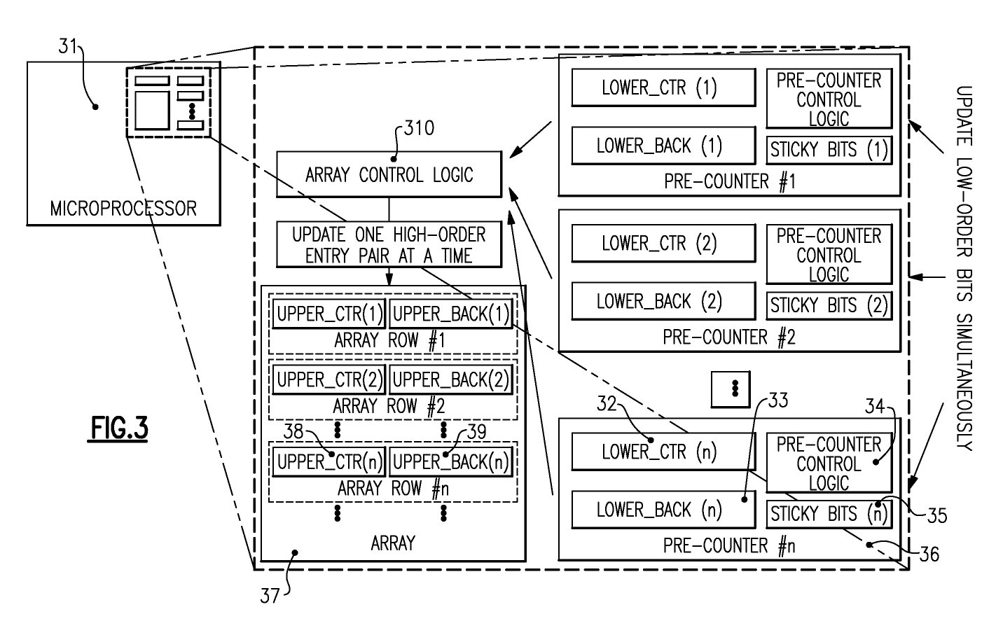

According to an embodiment of the invention, reduced power consumption of a microprocessor 31 employing speculative counting resulting in an increased efficiency may be achieved by re-using already available storage within the microprocessor 31 for a speculative counting mechanism (FIG. 3).

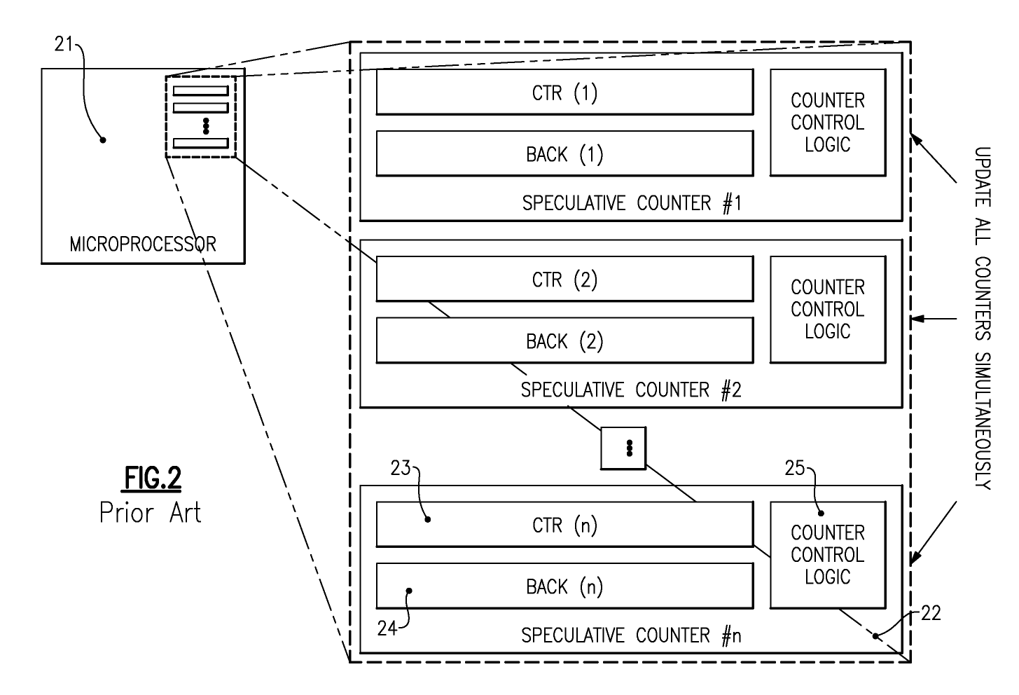

In order to implement microprocessor 31, according to an embodiment of the invention, the speculative counting mechanism 22 of a microprocessor 21 that comprises a counter 23 and an associated backup register 24 plus a control logic 25 is split (FIG. 2): The counter 23 is split into a first part 38, containing the high-order bits of the counter value, and a second part 32, containing the low-order bits of the counter value. Similarly, the backup register 24 is split into a first 39 and second 33 part. For each instance of the speculative counting mechanism, the corresponding first parts 38, 39 are stored in the same row of, for example, a trace array 37. Similarly, in place of the counter control logic 25, there is now a control logic 34 for updating the second parts, and an array control logic 310 handling array row updates. Furthermore, four sticky bits 35 are required for coordinating changes between the first 38, 39 and second 32, 33 parts; these comprise one sticky bit each for the carry-out from the second parts 32, 33 as well as one sticky bit for RESET events and one for STORE events. The second parts 32, 33 together with the pre-counter control logic 34 and the sticky bits 35 forms a so-called pre-counter 36.

As the diagram shows, through the pre-counters 36, the low-order bits of the counter value can be updated continuously. The array control logic 310 then periodically propagates these updates to the first parts 38, 39 that are stored in, for example, trace array rows.

Trace arrays are ideal to be re-used particularly when using the speculative counting mechanism for a PMU, since PMU and trace arrays are normally used in disjoint phases of a microprocessor's 31 product life cycle.

Now, according to an embodiment of the invention, at least some rows of the trace array 37, together with the dedicated pre-counters 36, form a new, split speculative counting mechanism offering the same functionality and accuracy of counting as the prior art mechanism 22.

In order to use the new, split speculative counting mechanism, the handling of the data handled by the speculative counting mechanism has to be modified.

This is achieved by first splitting the data of the speculative performance counting handled by the speculative counting mechanism in high- and low-order bits.

Second, the high order bits are stored in the first parts of the counter and the backup register, i.e. in a typically slower but more efficient storage on the microprocessor, such as, for example, a trace array row.

Third, the low order bits are stored in at least one dedicated pre-counter forming the second part of at least one counter and/or one backup register. Those pre-counters have to be integrated into the microprocessor 31. Those dedicated pre-counters are smaller in chip area and power consumption than a single or a set of complete speculative counting mechanisms according to the prior art actually integrated in microprocessors to track the occurrence of performance related events inside the microprocessor.

Fourth, the first parts of the counter and the backup register, such as, for example, the trace array rows, are updated periodically, for example, in round-robin fashion, and fifth, the carry-out from the second part of the counter and/or the backup register is saved and propagated to high-order bits when the corresponding first part of the counter and/or the backup register is next updated respectively.

Thereby the pre-counters are updated concurrently in each cycle.

It is thinkable to inject read/write requests between successive updates.

In order to achieve maximum efficiency, the counters and backup registers are preferably split such that the number of bits in the first parts of counter and backup register are significantly greater than the number of bits in the second parts. However, the pre-counters must be wide enough to prevent overflow in an update interval according to

wₘᵢₙ=log₂(rₘₐₓ·t)

with
wₘᵢₙ: the minimum width of the pre-counters,
rₘₐₓ: the maximum event rate per cycle.
t: the duration of an update interval for the high-order bits

The benefits of these techniques may include substantial reduction in latch count by re-using existing available storage for the speculative counting mechanism within a microprocessor employing speculative counting. Due to the reduction in latch count the power dissipation is also reduced and the area efficiency is increased. The invention may further enable more and wider counters within given constraints. It helps to keep the latch count reasonably low also within microprocessors employing a per-thread speculative counting.

As shown in FIG. 3, the first parts 38, 39 of a given speculative counter, that is, the high-order bits of its counter value and backup value respectively, are both stored in the same trace array row. Because each row is only updated periodically, STORE and/or RESET events for a given speculative counter may have to be deferred until its corresponding array row is next updated. As the second parts, that is, the least significant bits of the counter value and backup value respectively, are both stored in dedicated pre-counters that are continuously updated, the STORE and/or RESET events can take effect for these parts of the speculative counter immediately.

The mechanism proposed further properly accounts for the occurrence of multiple STORE and/or RESET indications between successive updates to the array row holding the first parts of a given speculative counter.

In order to handle the split counters and backup registers, each instance of a speculative counter within the microprocessor 31 requires additional control logic 34 and a set of sticky bits 35.

Like the performance events that are to be counted, the RESET and STORE indicators can occur on a cycle-by-cycle basis. In contrast, only a single trace array row can be accessed in any given cycle. Consequently, a mechanism is required that correctly accounts for RESET and STORE events that relate to any of the speculative counters which have the first parts of their counter and backup register stored in any array row other than the one currently being updated. Because the interval between successive updates to any given array row can span a considerable number of cycles, the mechanism needs to properly handle the occurrence of multiple RESET and/or STORE events in the course of a single update interval.

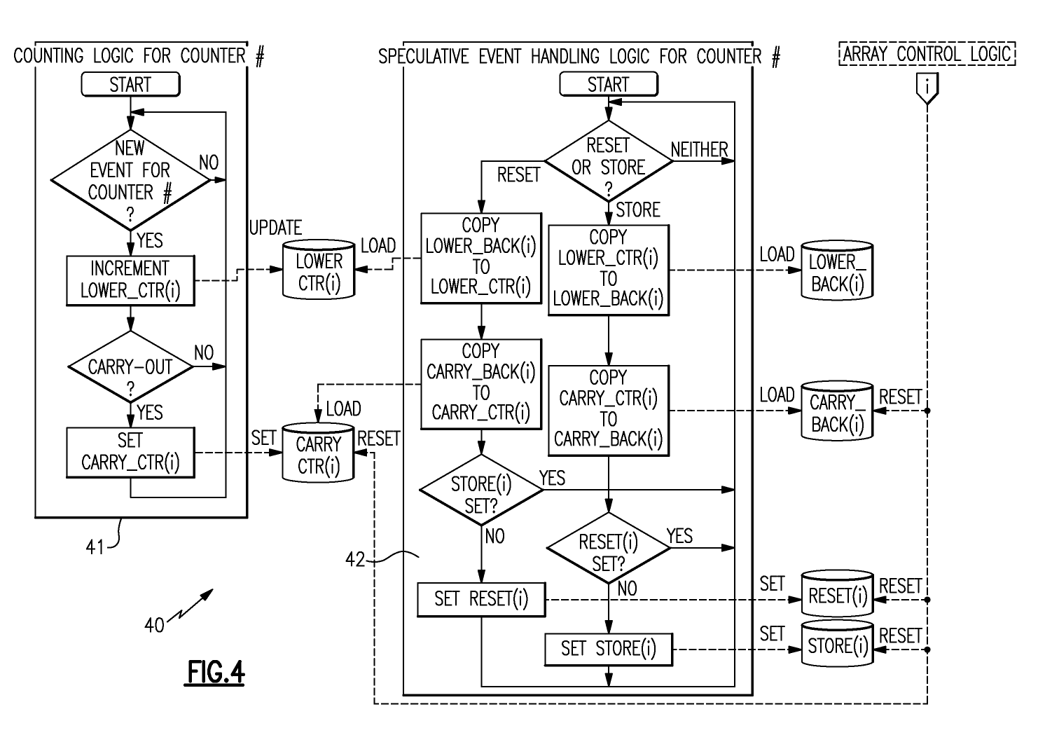

FIG. 4 presents a flow chart 40 that describes the mode of operation of the pre-counter control logic implementing this functionality:

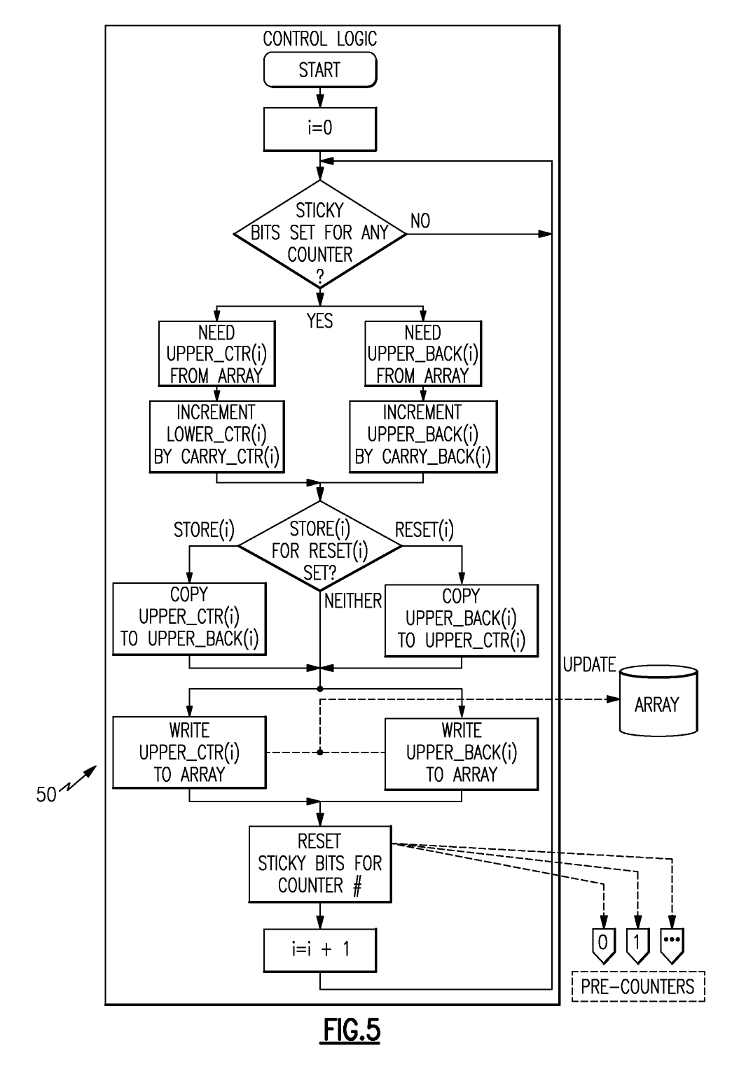

The subdiagram 41 in the left part of FIG. 4 shows the process that is responsible for handling incoming performance data to be counted: From a starting state, the logic waits until new events that should be counted become available. When that happens, the second part of the counter, marked LOWER_CTR(i) in FIG. 4, where i denotes the index of a given speculative counting mechanism if multiple are present inside the microprocessor, is incremented. In case doing so generates a carry-out from LOWER_CTR(i), a sticky carry bit designated as CARRY_CTR(i) in FIG. 4 and FIG. 5 is set. Finally, the process begins anew.

The right part of FIG. 4 shows another flow chart 42 representing the logic that is responsible for handling incoming RESET and STORE events:

From a starting state, the logic waits until either a RESET or a STORE event occurs (both cannot occur at the same time). When a STORE event occurs, LOWER_CTR(i) is copied into the second part of the backup register, denoted as LOWER_BACK(i) in FIG. 4, overwriting its current value. Additionally, CARRY_CTR(i) is copied into a second sticky carry bit, which is associated with the backup register, and designated CARRY_BACK(i) in FIG. 4 and FIG. 5. After that, a third sticky bit, called RESET(i) in FIG. 4 and FIG. 5, is checked. If it is not already set, a fourth sticky bit, called STORE(i) in FIG. 4 and FIG. 5, is set. Finally, the process begins anew.

When a RESET event occurs, on the other hand, LOWER_BACK(i) is copied into LOWER_CTR(i), overwriting its previous value. In addition, CARRY_BACK(i) is copied into CARRY_CTR(i). Afterwards, STORE(i) is checked. If it is not already set, RESET(i) is set. Finally, the process begins once again.

The RESET(i) and STORE(i) sticky bits represent the fact that a RESET or STORE indication, respectively, was the first to occur in a given update interval. Any further subsequent RESET and/or STORE indications that occur in the same update interval only relate to events that have accumulated since the first indication. Assuming appropriately sized pre-counters, these events are always going to be wholly represented by the second parts of the counter and backup register, i.e. LOWER_CTR(i) and LOWER_BACK(i). These subsequent indications can therefore be ignored for the purpose of updating the first parts of the counter and backup register which are stored in e.g. a trace array.

An additional array control logic 310 is required for handling updates to the first parts 38, 39 of the speculative counting mechanisms, which are stored, for example, in a trace array 37. FIG. 5 shows a flowchart 50 depicting the mode of operation of an exemplary implementation of this logic that supports multiple speculative counters and updates the corresponding trace array rows in a sequential, round-robin fashion:

From the starting state, the logic initially selects the first speculative counter, denoted by j=0, as the current speculative counter. It then waits until any speculative counter has any of its four sticky bits CARRY_CTR(i), CARRY_BACK(i), RESET(i) or STORE(i) set.

Once the logic detects that at least one sticky bit is set for any speculative counter, it first proceeds by handling the currently selected speculative counter, represented by the index j.

For the current speculative counter, the logic first reads the first part of the associated counter, denoted as UPPER_CTR(j) in FIG. 5, and the first part of the associated backup register, denoted here as UPPER_BACK(j), from the array. It then proceeds to increment these values by the current contents of CARRY_CTR(j) and CARRY_BACK(j) respectively. These actions can be performed concurrently for counter and backup register.

Subsequently, the logic examines the RESET(j) and STORE(j) sticky bits associated with the current speculative counter. The previously explained pre-counter control logic ensures that at most one of these two sticky bits can be set at any given time. If the STORE(j) bit is set, UPPER_CTR(j) is copied into UPPER_BACK(j), overwriting its previous value. Similarly, if RESET(j) is set, UPPER_BACK(j) is copied into UPPER_CTR(j), overwriting the latter's previous value.

The logic then proceeds to write the updated UPPER_CTR(j) and UPPER_BACK(j) values associated with the current speculative counter back into, for example, the trace array.

Finally, all sticky bits associated with the current speculative counter, namely CARRY_CTR(j), CARRY_BACK(j), RESET(j) and STORE(j), are cleared. Each of the numbered connector symbols in FIG. 5 connects to one of the instances of the logic corresponding to FIG. 4.

Once all of the above steps are completed for the current speculative counter, the logic selects the next speculative counter as the current speculative counter, denoted by j=j+1, and proceeds to check if there are still any sticky bits set on any of the speculative counters. Thus, the logic iterates over all speculative counters as long as there is still at least one counter left that has any of its sticky bits set.

Although FIG. 5 indicates that the individual speculative counters are updated in a sequential fashion, this row selection scheme is only meant to be of exemplary nature; another technique for selecting the next speculative counter to be serviced can be implemented to improve performance at the cost of increased hardware complexity.

When software issues a store operation to a speculative counter, both part of the associated backup register are initialized to the same values as the corresponding parts of the associated counter. For reads from the speculative counter, the content of the backup register is returned. In this manner, only non-speculative events are reported to software. The speculative portion of the events, which is the result of instructions that might still subsequently be discarded, for example, due to a branch mispredict, is not visible to software.

As described, the rewind counter implementation according to an embodiment of the invention maintains all of the functionality of current techniques, fully latch-based implementations, while at the same time offering significant reduction in the number of latches required. The interfaces exposed to both software and hardware units generating the events and control signals remain unchanged compared to current implementations, facilitating easy integration into existing designs.

While embodiments of the present invention have been described in detail, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A method to reduce power consumption and chip area of a microprocessor employing speculative performance counting with at least one speculative counting mechanism comprising at least one counter and at least one backup register, the method comprising:
splitting the counter and the backup register of the speculative counting mechanism into two parts each, re-using at least a part of storage within the microprocessor as first parts of the counter and the backup register respectively;
integrating at least one pre-counter into the microprocessor as second parts of the counter and the backup register respectively;
splitting the data of the speculative performance counting handled by the speculative counting mechanism in high-order bits and low-order bits;
storing the high order bits in the first parts of the counter and the backup register;
storing the low order bits in the second parts of the counter and the backup register;
updating the first parts of the counter and the backup register periodically; and
saving and propagating the carry-out from the second part of the counter and/or the backup register to high-order bits when a corresponding first part of the counter and/or the backup register is next updated respectively.

2. The method according to claim 1, wherein the pre-counters are updated concurrently in each cycle.

3. The method according to claim 1, wherein read/write requests are injected between successive updates.

4. The method according to claim 1, wherein the storage re-used as first parts of the speculative counting mechanism comprises at least a row of a trace array.

5. The method according to claim 1, wherein the speculative performance counting is employed in a performance monitoring unit comprising the split speculative counting mechanism.

6. A speculative counting mechanism for a microprocessor employing speculative performance counting, said speculative counting mechanism comprising at least one counter and at least one backup register, said speculative counting mechanism comprising:
at least one counter and at least one backup register, the counter and the backup register both comprise first and second parts, wherein the first parts are formed by storage within the microprocessor, and wherein the second parts are formed by at least one dedicated pre-counter integrated into the microprocessor,
wherein the data of the speculative performance counting handled by said speculative counting mechanism are split in high-order bits and low-order bits in a way that the high order bits are stored in the first parts of the counter and the backup register and the low order bits are stored in the second parts of the counter and the backup register, and
wherein the first parts of the counter and the backup register are updated periodically and the carry-out from a second part of the counter and/or the backup register is saved and propagated to high-order bits every time the corresponding first part of the counter and/or the backup register is next updated.

7. The speculative counting mechanism according to claim 6, wherein the first parts of the counter and the backup register are stored in at least a part of a trace array.

8. The speculative counting mechanism according to claim 6, wherein the speculative counting mechanism comprises a performance monitoring unit.

9. A microprocessor employing speculative performance counting with at least one speculative counting mechanism comprising:
at least one counter and at least one backup register, wherein the counter and the backup register are split into a first and a second part respectively, wherein the first part of the counter and the backup register are formed by storage within the microprocessor, and wherein the second part of the counter and the backup register are formed by at least one dedicated pre-counter integrated into the microprocessor,
wherein the data of the speculative performance counting handled by the speculative counting mechanism are split in high-order and low-order bits,
wherein the high order bits are stored in the first part of the counter and the backup register and the low order bits are stored in the second part of the counter and the backup register, and
wherein the first part of the counter and the backup register are updated periodically and the carry-out from the second part of the counter and/or the backup register is saved and propagated to high-order bits every time the corresponding first part of the counter and/or the backup register is next updated.

10. The microprocessor according to claim 9, wherein the first part of the counter and the backup register are stored in at least a part of a trace array.

11. The microprocessor according to claim 9, wherein the microprocessor comprises a performance monitoring unit comprising the split speculative counting mechanism.

12. The microprocessor according to claim 10, wherein the microprocessor comprises a performance monitoring unit comprising the split speculative counting mechanism.
